(19) United States
(12) Patent Application Publication
(10) Pub. No.: US 2006/0099325 A1
(43) Pub. Date: May 11, 2006

(54) Vegetable protein preparations and use thereof

(75) Inventors: Christian Schafer, Rheinfelden-Eichsel (DE); Simone Bahary-Lashgary, Minden (DE); Andreas Wasche, Langenbach (DE); Peter Eisner, Freising (DE); Udo Knauf, Munchen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Fraunhofer-Gesellschaft Zur Forderung Der Angewand Forschung E.V., Munchen (DE)

(21) Appl. No.: 10/517,714

(22) PCT Filed: Jun. 11, 2003
(86) PCT No.: PCT/EP03/06121

§ 371 Date: Oct. 7, 2005

(30) Foreign Application Priority Data
Jun. 12, 2002 (DE) 102 27 184.4
Jun. 17, 2002 (DE) 102 27 044.9

(51) Int. Cl. A23J 1/00

(52) U.S. Cl. 426/656

(57) ABSTRACT

The invention relates to vegetable protein preparations (isolates and concentrates) with improved sensory properties due to enzymatic treatment of the raw material with a lipase during the isolation process and the use of these protein preparations.

The invention relates to vegetable protein preparations (isolates and concentrates) with improved sensory properties due to enzymatic treatment of the raw material with a lipase during the isolation process, and the use of these protein preparations.

In the food and animal feed industry, vegetable protein preparations are used as ingredients in many areas. These influence the products of the food industry with respect to their functional and sensory properties. There may be mentioned hereby product stability, product texture or nutritional value. The sensory properties of vegetable protein preparations are thereby independent of the residual lipid content, in particular of the proportion of the phospholipid fraction. By oxidation, splitting of peroxides and hydroperoxides into aldehydes, ketones and free fatty acids, smell and taste are negatively affected (so-called off-flavour). The obtainment of vegetable protein preparations from oleaginous seeds is generally effected by shelling and flock spraying and subsequent deoiling of the flakes with organic solvent. The fat content of the raw material is consequently reduced by applying thermally gentle methods (60-70°; below the denaturation temperatures of the protein) to values of 1-2% residual fat. The remaining lipids are concentrated in the protein fraction during protein isolation and affect the sensory properties negatively (bitter, rancid taste and smell). This off-flavour is transferred into foods when using protein preparations and is undesired.

The proportion of fat and fatty materials of the seeds is 5-21%. It is therefore particularly important to remove fat and fat-accompanying substances. In the state of the art, the process has thereby been implemented to date such that, by means of methods such as pressing and/or extraction with organic solvents, the predominant part of the lipid fraction is removed prior to extraction of the proteins. According to the type of extraction which is applied, the remaining proportion of the phospholipid fraction in the protein preparation is of a varying level. In general, higher phospholipid values are found in the case of CO₂ extracted seeds. However, due to oxidation during the protein isolation and drying process and during storage, phospholipids are inclined to form smell- and taste-impairing decomposition products (e.g. hexanal). It is therefore particularly important that the fatty substances and fat-accompanying substances are removed as extensively as possible during the extraction.

Starting from here, it is the object of the present invention to propose vegetable protein preparations which, relative to the state of the art, contain a significantly reduced content of lipids or lipid-accompanying substances.

This object is achieved by the features of patent claim 1. The sub-claims display advantageous developments. The use of novel vegetable protein preparations is indicated in patent claim 11.

It is hence proposed according to the invention to produce vegetable protein preparations in that, during protein extraction, a lipase is added in the aqueous phase. It was shown surprisingly that when a lipase is added during protein extraction, protein preparations are obtained which have significantly better sensory properties than the comparable products without the addition of these enzymes. As was able to be detected on the basis of NMR spectroscopy, the protein preparations according to the invention, relative to the protein preparations of the state of the art as they have been known to date, show a significantly smaller residual lipid content. As a result of the fact that now a significantly smaller residual lipid content is present, protein preparations are obtained which, when they are used in the food and animal feed industry, lead to significantly better product qualities with respect to the off-flavour.

It has emerged that it is preferred if implementation takes place during the production of the protein preparations according to the invention such that firstly a pre-extraction and then subsequently at least one further extraction are implemented. Advantageously, neutralisation and drying e.g. spray drying, follow thereon.

The best results were achieved thereby if the enzyme was added in excess to the first protein extraction. A further preferred embodiment proposes, prior to the actual protein extraction, to implement a deoillng by pressing and/or extraction with an organic solvent, such as n-hexane or iso-hexane or even with CO₂.

It has proved furthermore to be advantageous if the neutralised protein preparation was thermally treated prior to drying. Favourable temperatures are hereby in the range of 50-100° C., preferably in the range of 75-85° C. Drying can be implemented over a few minutes, preferably 5-15 minutes. It is now achieved by these method measures that the enzyme is inactivated and a food-grade faultless application is ensured as a result.

In the case of the lipases, all lipases which are known per se in the state of the art can be used. Examples of this are glycerol ester-hydrolases, triacylglycerol-lipases, triglyceride-lipases and triacylglycerol-acyl hydrolases (EC3.1.1.3). These enzymes belong to the main class of hydrolases.

The essential properties of these lipases can be seen in the fact that they have activities relative to phospholipids, glycolipids and triglycerides and accelerate conversion of these products in water-soluble products (1, 3 specific activity on the glycerol frame). It has emerged that, when as described above, the protein preparations are produced, the products split by the enzymes during the protein isolation are jointly washed out so that hence the production of protein preparations with an extremely low content of residual lipids and hence with increased sensory quality is possible.

The invention includes furthermore, with respect to vegetable protein preparations, all proteins which are known per se to date from the state of the art. In principle, all protein- and oleaginous seeds, cereals and leaf proteins are usable. Concrete examples are: soya, rape, lupin, mustard, flax, coconut, sesame, sunflower, groundnut, cotton, rye, wheat, maize, rice and alfalfa.

The invention is explained subsequently in more detail with reference to an example and several drawings. There are thereby shown:

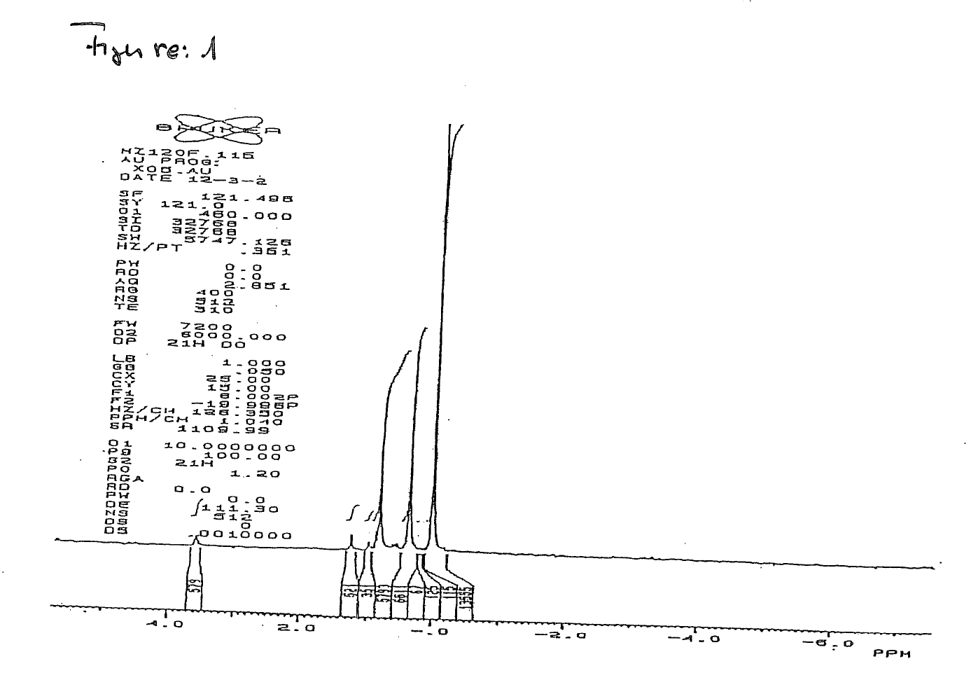

FIG. 1 an NMR spectrum of the phospholipid content of the raw material;

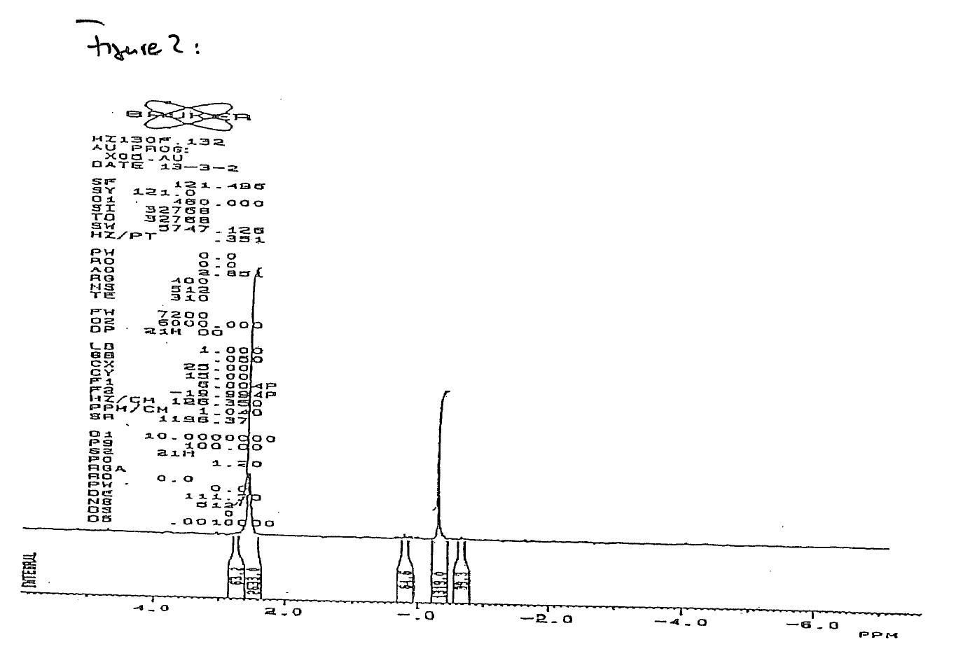

FIG. 2 an NMR spectrum relating to the phospholipid content of an isolate;

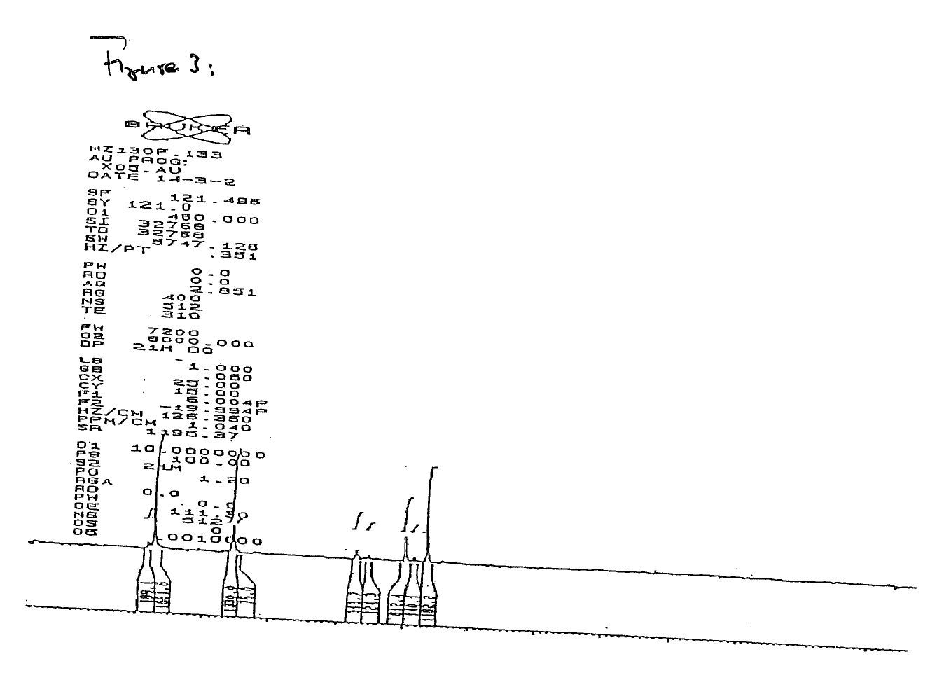

FIG. 3 an NMR spectrum of the phospholipid content of an isolate with lipase application;

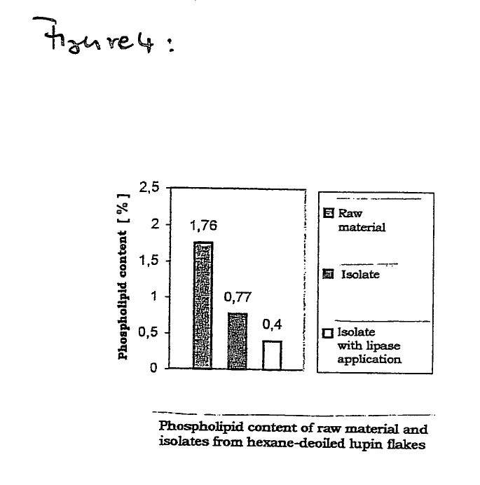

FIG. 4 shows in graphic representation the phospholipid content of raw material and isolates with and without lipase application of hexane-deoiled lupin flakes;

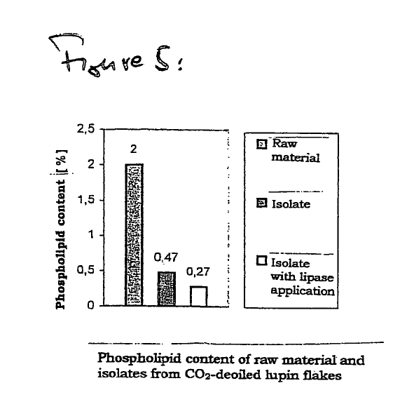

FIG. 5 shows the phospholipid content of raw materials and isolates with and without application of CO₂-deoiled lupin flakes.

### EMBODIMENT

Material and Method:

1. Raw materials
white flakes from Lupinus albus Tip Top hexane-deoiled and CO₂-deoiled

2. Enzyme
lipase preparation Lipopan F, Novozymes Company

3. Protein isolation
pre-extraction, two protein extractions
neutralisation, spray drying
drying (Büchi: laboratory spray dryer)

The enzyme preparation was added in excess to the first protein extraction. Prior to drying, the neutralised protein preparation was thermally treated (80° C., 10 min). The enzyme was hence inactivated and a food-grade faultless application was ensured.

For reasons of comparability, the protein isolates, which were produced by means of lipase application and those conventionally isolated, were subjected to thermal treatment.

4. Sensory analysis:
By means of a mixed skilled panel (composition: 2 female, 2 male, 2 smokers, 2 non-smokers), the protein isolates were evaluated, in a blind tasting with random sequence of samples, with respect to the sensory properties.

Results:

Phospholipid Contents:

As shown by FIGS. 1 to 3, a significant reduction in the phospholipids in the protein isolate is achieved by the application of the lipase.

FIGS. 4 and 5 show very clearly that the protein preparations according to the invention, relative to the state of the art, i.e. relative to a production method in which no lipase was used, have signifcantly superior properties. This surprising result leads to the above-described superior sensory properties.

Sensory Analysis:

Appearance/Colour:

With respect to colour, both raw materials (hexane- and CO₂-deoiled) were white to yellowish. The isolates with and without Lipopan white.

Smell:

Both raw materials had a cereal-like, bean-like smell. Isolates with and without Lipopan were neutral with respect to smell.

Taste:

The raw materials were described as varying from sweet to bitter and bean-like to metallic. Both raw materials had a slightly rancid aftertaste.

The conventionally extracted isolates were both described as slightly rancid and bitter. The difference resided in the fact that the hexane-deoiled isolate was described additionally as bean-like and raw. The isolates produced with lipase application were significantly preferred relative to the conventionally extracted isolates. The hexane-deoiled isolate with Lipopan was described as slightly raw, somewhat fruity and sweet and had a significantly stronger taste than the CO₂-deoiled isolate. The CO₂-deoiled isolate with Lipopan was described by terms such as cereal-like, bean-like raw, slightly bitter and metallic. A rancid aftertaste was not described for the isolates produced by means of lipase application.

1. Vegetable protein preparation, producible by extraction from the seeds with a solvent, comprising implementing the extraction in the presence of a lipase, the residual phospholipid content being ≦0.4%.

2. Protein preparation according to claim 1, wherein a pre-extraction and at least one protein extraction are implemented.

3. Protein preparation according to claim 1, wherein the lipase is added in excess during the protein extraction.

4. Protein preparation according to claim 1, wherein a deoiling is implemented prior to the protein extraction by pressing and/or extraction with an organic solvent or CO₂.

5. Protein preparation according to claim 4, wherein the organic solvent is selected from n-hexane and iso-hexane.

6. Protein preparation according to claim 1, wherein a neutralization and drying is effected after the last protein extraction.

7. Protein preparation according to claim 6, wherein the neutralized protein preparation was subjected to a thermal treatment prior to drying.

8. Protein preparation according to claim 1, wherein the lipases are selected from glycerol esterhydrolases, triacylglycerol-lipases, triglyceride-lipases, triglycerolacyl hydrolases (EC3.1.1.3).

9. Protein preparation according to claim 1, wherein the proteins are selected from protein- and oleaginous seeds, cereals and leaf proteins.

10. Protein preparation according to claim 9, wherein the proteins are selected from soya, rape, lupin, mustard, flax, coconut, sesame, sunflower, groundnut, cotton, rye, wheat, maize, rice and alfalfa.

11. Use of the protein preparation according to claim 1 in the food and animal feed industry.

12. Method for producing a vegetable protein preparation by extraction from the seeds with a solvent, wherein the extraction is implemented in the presence of a lipase.

13. Method according to claim 12, wherein a pre-extraction and at least one protein extraction are implemented.

14. Method according to claim 12, wherein the lipase is added in excess during the protein extraction.

15. Method according to claim 12, wherein a deoiling is implemented prior to the protein extraction by pressing and/or extraction with an organic solvent or CO₂.

16. Method according to claim 15, wherein the organic solvent is selected from n-hexane and iso-hexane.

17. Method according to claim 12, wherein a neutralization and drying is effected after the last protein extraction.

18. Method according to claim 17, wherein the neutralized protein preparation was subjected to a thermal treatment prior to drying.

19. Method according to claim 12, wherein the lipases are selected from glycerol esterhydrolases, triacylglycerol-lipases, triglyceride-lipases, triacylglycerol-acyl hydrolases (EC3.1.1.3).

20. Method according to claim 12, wherein the proteins are selected from protein- and oleaginous seeds, cereals and leaf proteins.

21. Method according to claim 20, wherein the proteins are selected from soya, rape, lupin, mustard, flax, coconut, sesame, sunflower, groundnut, cotton, rye, wheat, maize, rice and alfalfa.
